(19) United States
(12) Patent Application Publication
(10) Pub. No.: US 2004/0217599 A1
(43) Pub. Date: Nov. 4, 2004

(54) Handle mechanism for controlling a pivotal door of a vehicle

(76) Inventor: Hanako Ueda, Komaki-shi (JP)

Correspondence Address: Rabin & Berdo, P.C., Suite 500, 1101 14th Street, Washington, DC, 20005, US

(21) Appl. No.: 10/426,859

(22) Filed: May 1, 2003

(51) Int. Cl. E05C 3/06

(52) U.S. Cl. 292/217

(57) ABSTRACT

A handle mechanism for controlling a pivotal door of a delivery vehicle includes a handle adapted to pivotally connect to the pivotal door, an axle pivotally connected to the handle via a connector extending out of the axle, two retainers adapted to be securely mounted on the pivotal door to receive distal ends of the axle and a lock system. The lock system includes a latch pivotally received in the housing to alternatively restrict the pivotal movement of the handle and a tongue to alternatively restrict the pivotal movement of the latch such that the handle is controlled by the movement of the tongue.

### BACKGROUND OF THE INVENTION

1. Field of the Invention

The present invention relates to a handle mechanism, and more particularly to a handle mechanism for controlling a pivotal door of a delivery vehicle. The handle mechanism has a latch pivotally received in a housing to alternatively lock and unlock movement of the handle so that when the latch is locked, the handle is restrained from operating the pivotal door. However, when the latch is released from the locked status, the handle is able to move to operate the movement of the pivotal door.

2. Description of Related Art

A delivery vehicle normally has a compartment at the back of the vehicle for carrying products or goods. The vehicle is equipped with pivotal doors for access to the goods. This kind of pivotal door has a controlling device to control the opening or closing of the pivotal doors.

With reference to FIGS. 8 and 9, the conventional controlling device of a pivotal door (60) of a delivery vehicle has a first sling plate (61) securely mounted on the pivotal door (60) and a second sling plate (62) pivotally mounted on the pivotal door (60) to selectively correspond to the first sling plate (61). A handle (63) extends through the first and second sling plates (61,62) to connect to a shaft (65) via a connector (64) which is integrally formed with the shaft (65). The shaft (65) has a top distal end and a bottom distal end. The top distal end and bottom distal end of the shaft (65) are respectively provided with a projection (66) formed with the shaft (65) to correspond to a stop (67) formed on the pivotal door (60).

However, opening this pivotal door (60) by means of the conventional controlling device requires both hands of the user, which is quite troublesome and inconvenient. Because the driver sometimes will also have to be the loader, and is required to carry many articles out of the vehicle at one time, it is almost impossible for the driver to spare a free hand to operate the controlling device, let alone use both hands. Laying down all the articles on the ground in order to use both hands may result in the danger of the articles getting wet by rain water or being run over by a passing vehicle.

To overcome the shortcomings, the present invention tends to provide an improved handle mechanism to mitigate the aforementioned problems.

### SUMMARY OF THE INVENTION

The primary objective of the present invention is to provide an improved handle mechanism having a handle pivotally connected to an axle which is provided with two extensions formed on two distal ends of the axle and is pivotally received between two retainers on the pivotal door of the delivery vehicle such that movement of the handle is able to pivot the axle to allow the extensions to force open the pivotal door.

Another objective of the present invention is to provide a locking system to selectively limit the pivotal movement of the hollow handle so that the user is able to secure the goods inside the vehicle.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the handle mechanism of the present invention;

FIG. 2 is an exploded perspective view of the locking system of the present invention;

FIG. 3 is an exploded perspective view with the latch assembled in the housing and the retraction element mounted on the bracket of the housing;

FIG. 4 is a rear side view of the assembled locking system of the present invention, wherein the stop is in engagement of the bottom portion of the latch so that the pivotal movement of the latch is limited;

FIG. 5 is a schematic view showing that the stop is pivoted to release the limit to the latch, wherein the stop is pivoted to lift the limit to the latch so that the latch is able to pivot;

FIG. 6 is a cross sectional view showing that the stop is in engagement with the latch to limit the movement of the latch so that the handle is secured in the locking system;

FIG. 7 is a schematic cross sectional view showing the pivotal movement of the stop lifts the limit to the latch to allow the latch to pivot so that the handle is able to be lifted;

FIG. 8 is a side view showing the conventional handle mechanism for a pivotal door of a delivery vehicle; and

FIG. 9 is a schematic view showing the movement of the handle to open the pivotal door.

### DETAILED DESCRIPTION OF THE PREFERRED EMBODIMENT

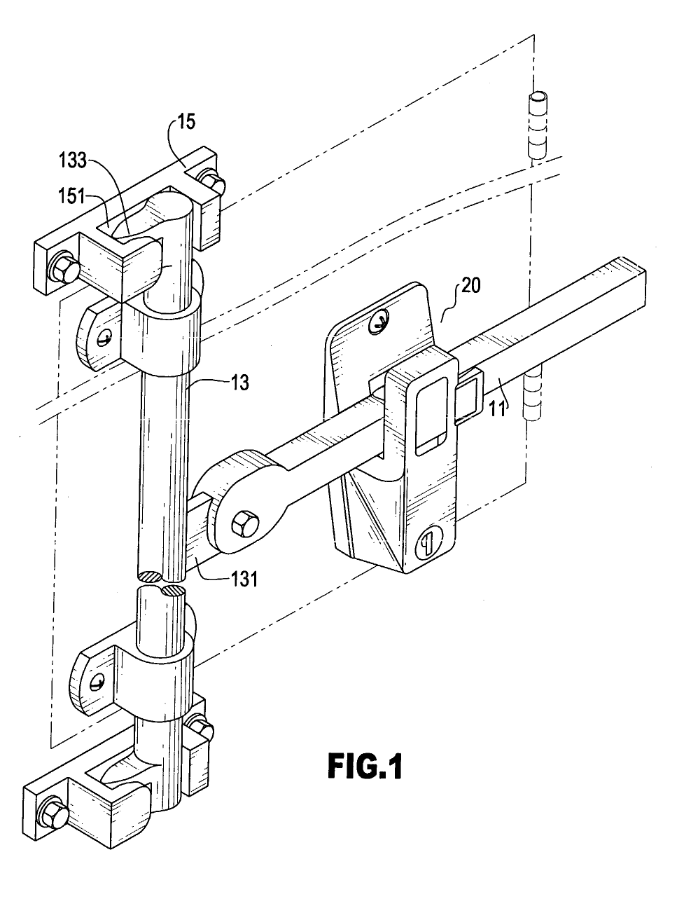

With reference to FIG. 1, the handle mechanism in accordance with the present invention includes a handle (11), an axle (13), two retainers (15) and a locking system (20).

The handle (11) is pivotally connected to the axle (13) via a connector (131) formed on and extended out from the axle (13). The axle (13) has two extensions (133) respectively formed on two distal ends of the axle (13). The two retainers (15) are adapted to be formed on a pivotal door of a delivery vehicle and each retainer (15) has a receiving space (151) defined therein to receive a corresponding one of the extensions (133). When the handle (11) is lifted relative to the axle (13) and pivoted to drive the axle (13) to pivot in the same orientation as that of the handle (11), each extension (133) abuts a side face in the receiving space (151) to force the pivotal door (not numbered) to open. Because the operation of the handle (11) to open the pivotal door is conventional in the art, further detailed description thereof is thus omitted.

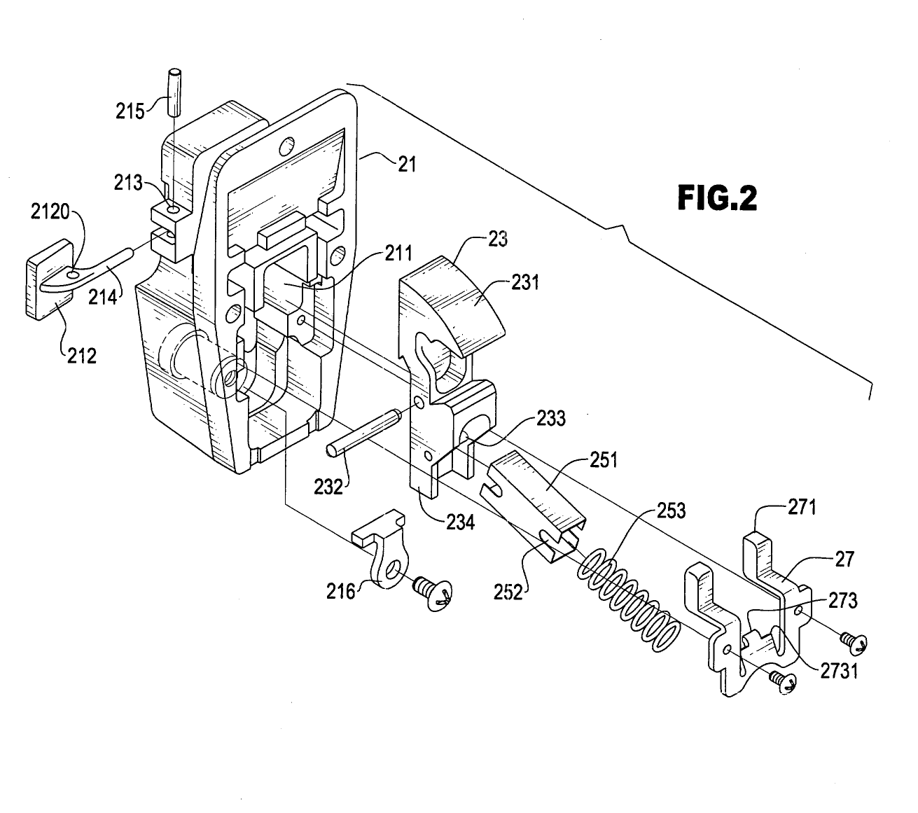

With reference to FIG. 2, the locking system (20) of the present invention includes a housing (21), a latch (23), a retraction element (25) and a bracket (27).

The housing (21) is securely mounted on the pivotal door and has a chamber (211) defined therein to receive the latch (23), a press (212) pivotally connected to an outer face of the housing (21) and provided with a through hole (2120) defined to correspond to a pivot hole (213) defined in a side of the housing (21) to correspond to a first pin (215) and a pressing arm (214) integrally formed with the press (212).

The latch (23) is pivotally received in the chamber (211) and has a latch head (231), a second pin (232) laterally extending through the latch (23) to abut two opposite side faces in the chamber (211) of the housing (21) such that the latch (23) is able to pivot inside the chamber (211) and a third pin (233) received between two legs (234) extending downward relative to the latch head (231).

The retraction element (25) is composed of an abutting tube (251) and a spring (253) received in the abutting tube (251). The abutting tube (251) has two open ends and two pairs of mutually aligned cutouts (252) respectively defined in two free ends of the abutting tube (251).

The bracket (27) has two arms (271) integrally extending out to be securely engaged with a side face in the chamber (211) of the housing (21) and a projection (273) formed between the two arms (271) to correspond to one pair of the cutouts (252) of the abutting tube (251).

Furthermore, the housing has a tongue (216) pivotally received in the chamber (211) to correspond to the legs (234) of the latch (23). The tongue (216) may be adapted to be driven by a key (not shown). That is, when a proper key is inserted into a lock core (not shown) and rotated, the tongue (216) is thus driven by the rotation of the key.

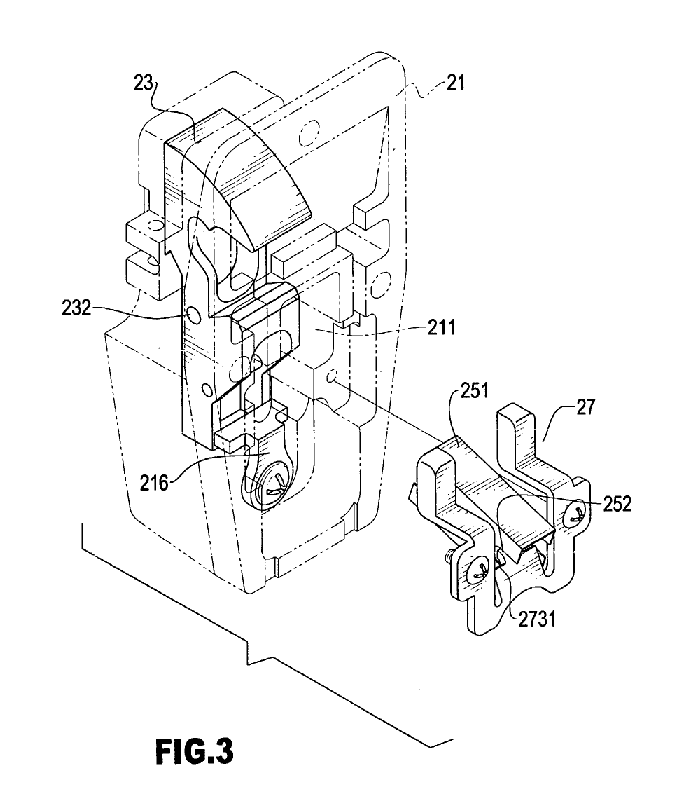

With reference to FIG. 3 and still taking FIG. 1 for reference, when the locking system of the present invention is in assembly, the tongue (216) is pivotally received in the housing (21) by a suitable manner well known in the art, e.g. a screw is applied to pivotally connect the tongue (216) to a side face in the housing (21). Then the latch (23) is received in the chamber (211) with the second pin (232) abutted to opposite side faces in the chamber (211) of the housing (21) to allow the latch (23) to pivot relative to the housing (21). The bracket (27) is then securely received in the chamber (211) by a suitable method that is well known in the art, e.g. screws are provided to securely mount the bracket (27) to the housing (21) with the projection (273) inserted into one open end of the abutting tube (251) to engage with a distal end of the spring (253) that is received in the abutting tube (251). In order to have better stability of the engagement between the projection (273) and the abutting tube (251), the projection (273) has two shoulders (2731) formed on opposite sides of the projection (273) such that when the projection (273) is inserted into the open end of the abutting tube (251), the two shoulders (2731) are received in the pair of cutouts (252) of the abutting tube (251).

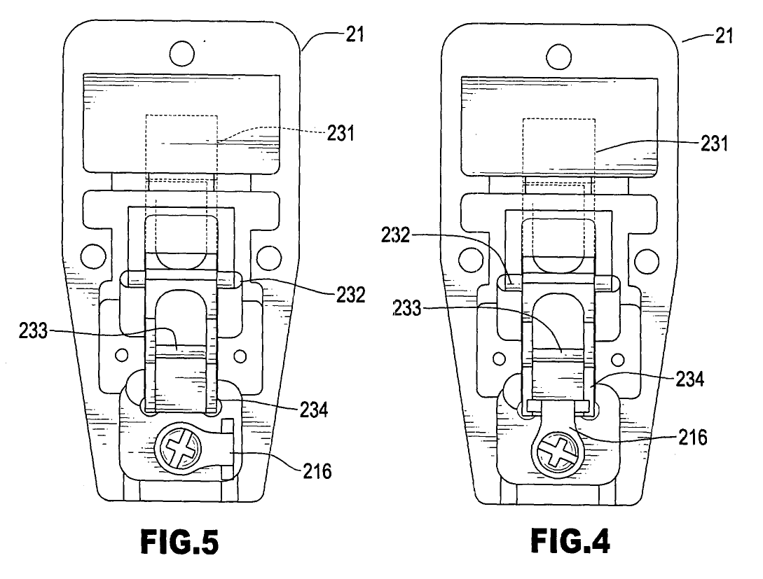

With reference to FIGS. 4 and 5, after the assembly of the locking system of the present invention, when the tongue (216) is in a locking status, the tongue (216) engages with the legs (234) of the latch (23) to limit pivotal movement of the latch (23). However, when the tongue (216) is pivoted by a proper key inserted into a lock core (shown in FIG. 1), the tongue (216) is pivoted from the locking status to a non-locking status, which releases the limit to the latch (23). That is, the tongue (216) is not in engagement with the legs (234) of the latch (23) any more so that the latch (23) is able to freely pivot. Therefore, after the latch (23) is able to freely pivot, the user may press downward the press (212) to force the pressing arm (214) to move the latch head (231). Because the latch (23) is pivotally received in the chamber (211) by the second pin (212), the movement of the latch head (231) by the pressing arm (214) allows the legs (234) to pivot inside the chamber (211). Because the third pin (233) is received in the other pair of cutouts (252) of the abutting tube (251), the pivotal movement of the legs (234) of the latch (23) extends the spring (253) inside the abutting tube (251) such that a recovery force is stored in the spring (253) to provide a recovery force to the latch (23) when the latch (23) is returned to the locking status.

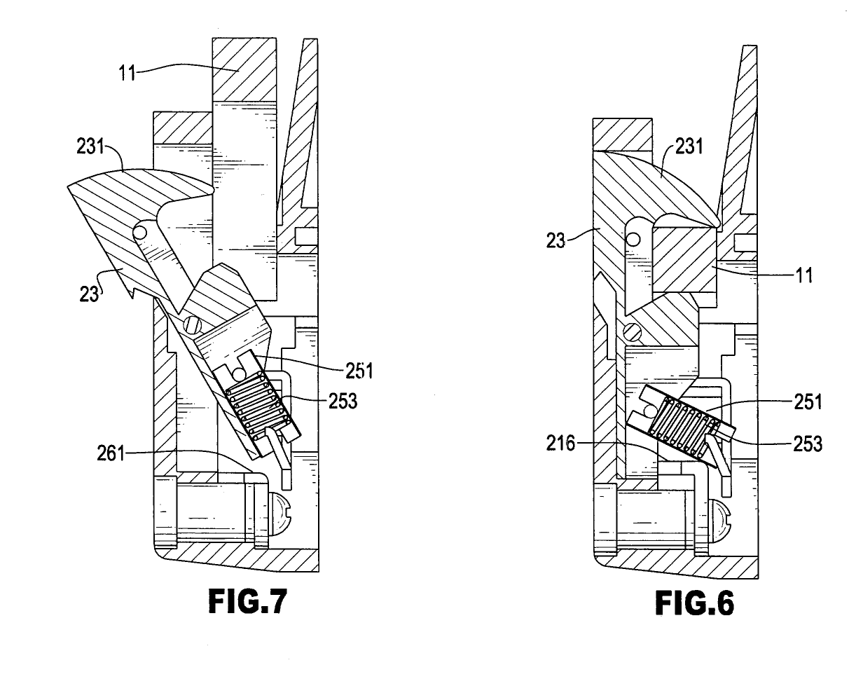

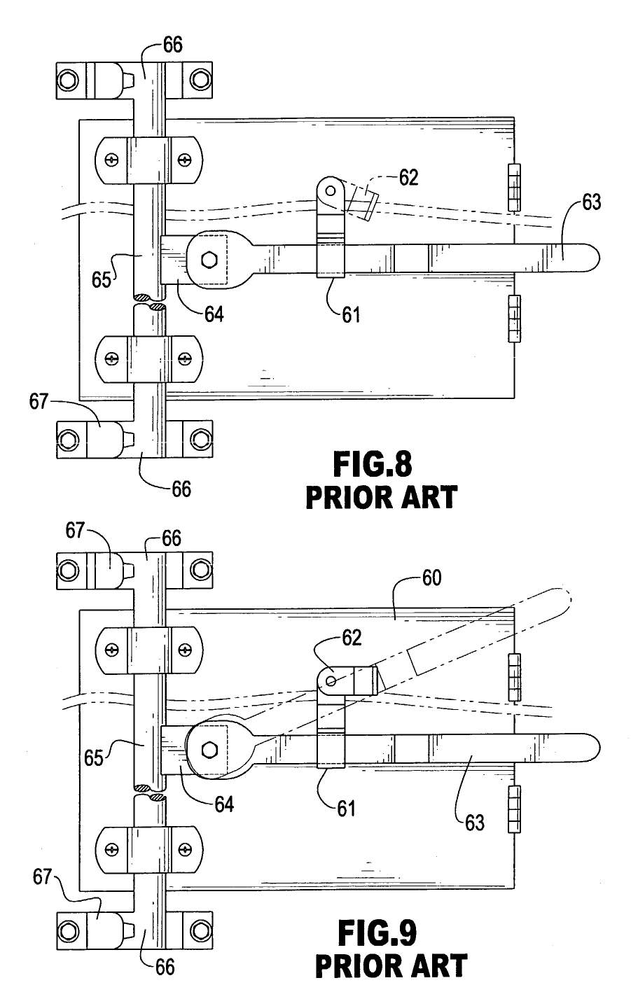

With reference to FIG. 6, it is noted that when the tongue (216) is in the locking status, due to the engagement of the legs (234) to the tongue (216), the latch (23) is immovable and therefore, the handle (11) is secured in the housing (21) by the latch head (231). However, when the tongue (216) is pivoted to disengage with the legs (234) of the latch (23), the latch (23) is able to be pivoted by the downward movement of the press (212) to force the pressing arm (214) to move the latch head (231), which allows the latch (23) to pivot and to extend the spring (253) inside the abutting tube (251). Thereafter, the handle (11) restricted in the housing (21) is able to be lifted by the user to operate the pivotal door.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A handle mechanism for controlling a pivotal door, the handle mechanism comprising:
a handle adapted to be pivotally mounted on the pivotal door;
an axle adapted to be pivotally mounted on the pivotal door and pivotally connected to the handle via a connector which is formed and extended out from the axle, wherein the axle has two extensions respectively formed on two distal ends of the axle;
two retainers adapted to be respectively formed on the pivotal door, each retainer having a receiving space defined to receive therein a corresponding one of the extensions such that when the handle is lifted relative to the axle and pivoted to drive the axle to pivot in an orientation the same as that of the handle, each extension abuts a side face in the receiving space to force the pivotal door to open; and
a locking system for alternatively locking and unlocking pivotal movement of the handle, wherein the locking system has a latch pivotal relative to the handle and a tongue movably received between a first position to limit pivotal movement of the latch so as to limit movement of the handle and a second position to release the limitation to the latch so that the latch is able to pivot freely.

2. The handle mechanism as claimed in claim 1, wherein the locking system further has a housing adapted to be securely mounted on the pivotal door and having a chamber to pivotally receive therein the latch and a pivot hole defined to align with a through hole in a press which is pivotally connected to an outer face of the housing so that a first pin is able to be inserted in the aligned pivot hole and the through hole to allow the press to pivot relative to the housing to initiate the pivotal movement of the latch when the tongue is in the second position.

3. The handle mechanism as claimed in claim 2, wherein the latch of the locking system further has legs integrally extended downward to selectively engage with the tongue.

4. The handle mechanism as claimed in claim 2, wherein the latch has a second pin laterally extending through the latch to abut opposite side faces in the chamber to allow the latch to pivot inside the housing.

5. The handle mechanism as claimed in claim 2, wherein locking system further has an abutting tube with a spring received inside the abutting tube, the abutting tube is provided with a first pair of cutouts defined in a first distal open end of the abutting tube and a second pair of cutouts defined in a second distal open end of the abutting tube.

6. The handle mechanism as claimed in claim 3, wherein locking system further has an abutting tube with a spring received inside the abutting tube, the abutting tube is provided with a first pair of cutouts defined in a first distal end of the abutting tube and a second pair of cutouts defined in a second distal end of the abutting tube.

7. The handle mechanism as claimed in claim 4, wherein locking system further has an abutting tube with a spring received inside the abutting tube, the abutting tube is provided with a first pair of cutouts defined in a first distal end of the abutting tube and a second pair of cutouts defined in a second distal end of the abutting tube.

8. The handle mechanism as claimed in claim 5, wherein locking system further has a bracket with two arms securely connected to the housing, a projection formed between the two arms to extend into the second distal open end of the abutting tube and two shoulders formed on opposite sides of the projection to respectively abut the second distal open end of the abutting tube.

9. The handle mechanism as claimed in claim 6, wherein locking system further has a bracket with two arms securely connected to the housing, a projection formed between the two arms to extend into the second distal open end of the abutting tube and two shoulders formed on opposite sides of the projection to respectively abut the second distal open end of the abutting tube.

10. The handle mechanism as claimed in claim 7, wherein locking system further has a bracket with two arms securely connected to the housing, a projection formed between the two arms to extend into the second distal open end of the abutting tube and two shoulders formed on opposite sides of the projection to respectively abut the second distal open end of the abutting tube.

11. The handle mechanism as claimed in claim 7, wherein the latch has a third pin laterally extending through the latch to be received in the first pair of cutouts in the first distal open end of the abutting tube.

12. The handle mechanism as claimed in claim 8, wherein the latch has a third pin laterally extending through the latch to be received in the first pair of cutouts in the first distal open end of the abutting tube so that the abutting tube is securely received between the projection and the third pin of the latch and the pivotal movement of the press when the tongue is in the second position allows the spring to be extended to store therein a recovery force to the latch.

13. The handle mechanism as claimed in claim 9, wherein the latch has a third pin laterally extending through the latch to be received in the first pair of cutouts in the first distal open end of the abutting tube so that the abutting tube is securely received between the projection and the third pin of the latch and the pivotal movement of the press when the tongue is in the second position allows the spring to be extended to store therein a recovery force to the latch.

14. The handle mechanism as claimed in claim 10, wherein the latch has a third pin laterally extending through the latch to be received in the first pair of cutouts in the first distal open end of the abutting tube so that the abutting tube is securely received between the projection and the third pin of the latch and the pivotal movement of the press when the tongue is in the second position allows the spring to be extended to store therein a recovery force to the latch.

15. The handle mechanism as claimed in claim 11, wherein the latch has a third pin laterally extending through the latch to be received in the first pair of cutouts in the first distal open end of the abutting tube so that the abutting tube is securely received between the projection and the third pin of the latch and the pivotal movement of the press when the tongue is in the second position allows the spring to be extended to store therein a recovery force to the latch.
